(19) United States
(12) Patent Application Publication
(10) Pub. No.: US 2006/0010286 A1
(43) Pub. Date: Jan. 12, 2006

(54) Tape drive apparatus

(76) Inventors: Andrew Topham, Dursley (GB); Alastair Michael Slater, Malmesbury (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/174,783

(22) Filed: Jul. 5, 2005

(30) Foreign Application Priority Data
Jul. 6, 2004 (GB) 0415191.6

(51) Int. Cl. G06F 12/00

(52) U.S. Cl. 711/111; 711/150; 711/151

(57) ABSTRACT

Embodiments of the present disclosure provide apparatuses and methods involving a tape drive apparatus. Briefly described, in architecture, one embodiment of a tape drive apparatus, among others, can be implemented as follows. The tape drive apparatus comprises an interface for coupling at least first and second requesters to the tape drive apparatus, the interface being adapted to receive media control requests from the requestors and identifiers of the requesters; and logic circuitry for generating log entries and writing the log entries to a log. Each log entry indicates at least a type of one of the media control requests and the identifier of the respective requestor, the logic circuitry being adapted for identification of potentially conflicting ones of the media control requests received from different ones of the at least first and second requestors. Other apparatuses and methods are also included.

### CLAIM TO PRIORITY

This application claims priority to copending United Kingdom utility application entitled, “Tape Drive Apparatus,” having serial number GB 0415191.6, filed Jul. 6, 2004, which is entirely incorporated herein by reference.

### TECHNICAL FIELD

The present disclosure relates to the field of data backup, data archiving and recovery.

### BACKGROUND

It is known to backup data stored on primary storage, such as a hard disc of a computer system, in order to protect against a disaster that might otherwise irrecoverably destroy all or part of the data. Disasters, for example, may be fire, flood, computer virus, or simply accidental deletion of data. One of the main reasons for using magnetic tape as a backup storage media is that it provides a stable, reliable, and relatively cheap option for storing large volumes of backed-up data.

Backup application software which executes on a computer system typically provides the functions for enabling such computer system data to be both backed-up to, and restored from tape cartridge, which is written to and read from by a tape drive. Well-known backup application software includes ‘Replica’ from Stac, ‘ArcServe’ from Computer Associates, ‘BackupExec’ from Veritas and ‘Data Protector’ from HP. Well-known tape drives include DDS and LTO compliant tape drives, both available from HP.

An example of a technology that can be used for backup is the linear tape-open (LTO) technology. LTO technology is an “open format” technology, which means that users can have multiple sources of cartridges and compatible tape drives. The ULTRIUM format is the “high capacity” implementation of LTO technology.

Tape drives and tape cartridges which are compliant with ULTRIUM LTO are commercially available from Hewlett Packard and others. A LTO compliant cartridge has a non-volatile cartridge memory (LTO-CM) which is an intelligent memory chip embedded in the cartridge. It uses a radio frequency interface that eliminates the need for a physical power or signal connection between cartridge and tape drive. The LTO-CM is used for storing information which in other tape formats may be stored in the header at the beginning of the tape.

Generally, conventional backup methods provide for either file-by-file backup or image backup. In a file-by-file backup, the backup program copies one file at a time from the disk to the tape. Specifically, the program places all pieces of data for each file, irrespective of actual locations on the disk, into a single sequential block that is stored on the tape. Thus, a file-by-file backup can provide an incremental backup (wherein only those files that have changed since the last backup are written to tape), but is time consuming for a full backup.

In an image backup, the data image is read sequentially from the disk and written to the tape. Thus, in prior art systems in which the disk drive is substantially faster than the tape drive, an image backup can keep the tape drive streaming. However, current technology has significantly improved tape drive speed. In fact, in state of the art systems, the tape drive speed is actually equal to or greater than the disk drive speed—irrespective of whether it is actually a singular disk drive or an aggregation of them, in, for example a RAID configuration—which can cause interruptions in the data stream written to the tape media. Therefore these systems do not fully use the backup and restore performance of a state of the art tape drive.

U.S. Patent Application 20040068630 A1, which is entirely incorporated herein by reference, shows a system for providing an interleaved backup. The data from a plurality of primary data sources, such as disk drives or disk arrays, are interleaved and captured in a tape drive during a backup operation. The interleaving of data allows the overlap of read/write operations performed by the plurality of primary data sources, thereby optimizing the performance of the backup.

Thus, a heretofore unaddressed need exists in the industry to address the aforementioned deficiencies and inadequacies.

### SUMMARY

Embodiments of the present disclosure provide apparatuses and methods involving a tape drive apparatus. Briefly described, in architecture, one embodiment of a tape drive apparatus, among others, can be implemented as follows. The tape drive apparatus comprises an interface for coupling at least first and second requesters to the tape drive apparatus, the interface being adapted to receive media control requests from the requesters and identifiers of the requesters; and logic circuitry for generating log entries and writing the log entries to a log. Each log entry indicates at least a type of one of the media control requests and the identifier of the respective requestor, the logic circuitry being adapted for identification of potentially conflicting ones of the media control requests received from different ones of the at least first and second requestors.

Embodiments of the present disclosure can also be viewed as providing methods of writing log entries to a log of a tape drive apparatus. In this regard, one embodiment of such a method, among others, can be broadly summarized by the following steps: receiving media control requests from requesters coupled to the tape drive and identifiers of the requesters; generating log entries and writing the log entries to a log of the tape drive, each log entry indicating at least a type of one of the media control requests and the identifier of the respective requester; and identifying potentially conflicting ones of the media control requests received from different requesters using the log entries.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic block diagram showing one embodiment of a tape drive coupled to multiple host computers via a network.

FIG. 2 is a flow diagram illustrating an embodiment of a method for writing log entries to the log,

FIG. 3 is a flow diagram illustrating an embodiment of an analysis application program.

FIG. 4 is a flow diagram illustrating a further embodiment of a method for writing log entries to the log.

FIG. 5 is a schematic block diagram showing one embodiment of a tape drive coupled to multiple host computers via a SAN.

### DETAILED DESCRIPTION

In accordance with embodiment of the present disclosure, there is provided a tape drive apparatus comprising an interface for coupling at least first and second requestors to the tape drive apparatus. The interface is adapted to receive media control requests from the requestors and identifiers of the requesters. The tape drive apparatus has logic circuitry for generating log entries and writing the log entries to a log. Each log entry indicates at least a type of one of the media control requests and the identifier of the respective requester.

For example, the requesters are host computers that are coupled to the tape drive apparatus by means of a network, such as a storage area network (SAN) or Ethernet. The multiple host computers coupled to the tape drive apparatus can send media control requests, such as write, read, or re-wind commands, to the tape drive apparatus independently from each other. As a consequence the tape drive apparatus may receive an interleaved sequence of media control requests.

The log of the tape drive serves to record the history of media control requests that are received from the various requestors, e.g., host computers. In particular, the log facilitates to review the history of such media control requests for identification of potentially conflicting media control requests received from different requesters.

For example, a first host computer sends a sequence of write commands to the tape drive apparatus when a second host computer sends a rewind command to the tape drive apparatus. In response to the rewind command received from the second host computer, the tape drive apparatus rewinds the tape media to the beginning before continuing to execute the write commands received from the first host computer. As a consequence data that is written to the tape media after the rewinding of the tape media overwrites previously written data. By means of the log of the tape drive apparatus, such a situation can be detected and/or prevented.

In accordance with one embodiment, the log is circular. For example, the log stores a continuous list of the type of media control requests received from the requesters together with the respective identifiers of the requestors. In order to limit the size of the log, the log has a circular replacement mechanism to overwrite an oldest log entry by the newest log entry.

In accordance with a further embodiment, a log entry is generated and written to the log for each of the media control requests received from the requestors coupled to the tape drive apparatus. This has the advantage of providing access to a complete history of the received media requests, which, however, requires a relatively large memory for storing the log.

In accordance with a further embodiment, a log entry is only written to the log for a current media control request, if the current media control request is received from a different requestor than a previous media control request. This reduces the size of the log and also facilitates reviewing the history of past media control requests for identification of potentially conflicting media control requests, as generally only media control requests that are subsequently received from different requesters can be conflicting.

In accordance with a further embodiment, a previous log entry is read from the log in order to determine if the respective previous media control request and the current media control request are different. Only if this is the case, a log entry is written to the log for the current media control request.

In accordance with a further embodiment, the tape drive apparatus has a rule base. The rule base is used for identification of potentially conflicting media control requests received from different requestors.

In accordance with a further embodiment, a set of known error patterns is stored in the memory of the tape drive apparatus. Each error pattern comprises at least first and second consecutive types of media control requests that are known to be potentially conflicting.

For example, one of the error patterns is a rewind-type command that is followed by a write-type command. If a previous media control request stored in the log and the current media control request have been received from different requestors, the types of the previous and current media control requests are compared with the set of error patterns in order to check if the previous media control request and the current media control request have potentially conflicting types.

In accordance with a further embodiment, the tape drive apparatus generates one or more error signals if potentially conflicting media control requests are identified. For example, error messages are sent to both of the affected requestors, e.g., the requester of the current media control request and the requester of the previous media control request, in order to signal the error situation. If one of the requesters executes a backup and/or archive application receipt of the error message may abnormally terminate the backup or archiving procedure. This has the advantage that a user becomes aware of the fact that the backup or archiving operation needs to be repeated or completed.

In accordance with a further embodiment, the interface of the tape drive apparatus is compliant with the FibreChannel (FC) standard. This facilitates coupling of the tape drive apparatus to a storage area network (SAN) as FC is typically used as a communication protocol in a SAN. In the case of a SAN, the worldwide names (WWN) of the host computers can be used as the identifiers for generating the log entries. Alternatively another interface technology that uses similar identifiers as FibreChannel is used, e.g., Ethernet.

It is to be noted that the present disclosure is not limited to tape storage technology but that it can be used for other kinds of sequential storage devices that use a sequential storage media for writing and reading of data, such as backup or archive data.

In another aspect, one embodiment relates to a computer program product for analysis of the log. The computer program product can be a stand alone application, or it can form an integral part of a back up and/or archive application program. The log of the tape drive is read and the log entries are displayed for review by a user. The log entries enable the user to review the history of past media control commands received from various requesters for identification of a misconfiguration or another technical problem that has lead to an error situation, such as abnormal termination of a backup and/or archiving process.

Some embodiments are particularly advantageous in an SAN environment where multiple host computers are provided with a path to each tape drive apparatus. In such an environment, multiple host computers can communicate with the same tape drive apparatus, such that the sequences of commands received by that tape drive apparatus from the various host computers overlap.

A tape drive along with its associated tape media is a stateful device. Any host computer communicating with the tape drive apparatus assumes that it knows the state of the tape drive apparatus and its tape media based on the history of past interactions with the tape drive apparatus. For instance, if a host computer has sent a series of commands to the tape drive apparatus to write data to the tape media, then the host computer will infer that the tape drive apparatus has currently positioned the tape media such that it is located at the end of that series of data. If another host computer sends a rewind command to the tape drive apparatus, while the other host computer continues to send its sequence of write commands, that would cause a loss of previously written data due to an incorrect assumption of the tape media position.

By means of the log, a situation where potentially conflicting commands are received from different host computers can be identified by the tape drive apparatus itself and/or by an analysis application program. Unintentional overwriting of previously written data is prevented by signaling the potentially conflicting commands to the involved host computers. In response, the host computer that runs a backup and/or archive application stops the backup and/or archive procedure. The back up and/or archive procedure is restarted at the later point of time after the misconfiguration or other technical problem that has lead to the potentially conflicting commands has been resolved.

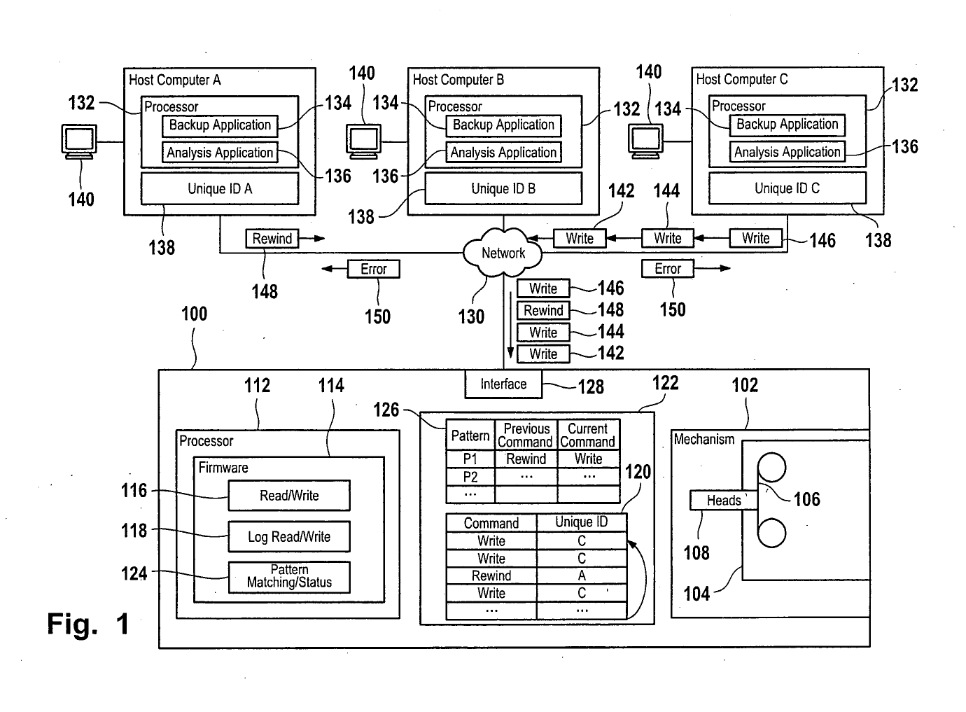

FIG. 1 shows tape drive 100 having tape drive mechanism 102 which loads and ejects tape cartridge 104 and winds tape media 106 of tape cartridge 104 forwards or backwards as required for reading and writing data. In a DDS (Digital Data Storage) tape drive the read/write heads 108 are mounted on a helical scanning drum that rotates to sweep the heads 108 past the tape media 106 in a motion oblique to the direction of travel of the tape media 106.

Processor 112 of tape drive 100 serves to execute firmware 114. Firmware 114 comprises instructions 116 for writing and reading backup or archive data to and from tape cartridge 104. In addition, firmware 116 comprises instructions 118 for generating, writing, and reading log entries of log 120 stored in memory 122 of tape drive 100. For some embodiments, memory 122 is a random access memory of tape drive 100. Alternatively log 120 can be stored on the tape media 106 or in a cartridge memory of tape cartridge 104. Storage of log 120 in memory 122 of tape drive 100 is, however, preferred, in some embodiments, for speed of access.

Firmware 116 comprises instructions 124 for identification of potentially conflicting commands that are sequentially received from different host computers and for sending respective error messages to the affected host computers.

A rule base 126 is stored in memory 122. The rule base 126 is used by the instructions 124 for identification of potentially conflicting commands that are sequentially received from different host computers. In one embodiment considered here, rule base 126 is implemented as a set of error patterns P1, P2, etc. Each of the error patterns has at least two consecutive command types that are potentially conflicting if received sequentially from different host computers. For example, error pattern P1 is a rewind type command followed by a write-type command. Another example is the issuance of a write filemark command followed by a write from different hosts or another sequence of commands from different hosts that may corrupt the logical format from at least one of the host's point of view. Tape drive 100 has data interface 128 for coupling tape drive 100 to communication network 130.

A number of host computers A, B, C, etc. are coupled to interface 128 by means of network 130. For example, host computer A has processor 132 for execution of backup and/or archive application program 134 and analysis application program 136. Depending on the implementation, analysis application program 136 can form an integral part of backup and/or archive application program 134. Alternatively, analysis application program 136 is a stand alone program that can be used independently from backup and/or archive application program 134.

Host computer A has storage 138 for storage of an identifier that unequivocally identifies host computer A. Host computer A also has display 140 for displaying log entries of the log 120 received by analysis application program 136 from tape drive 100 via network 130. The other host computers B, C, etc. coupled to interface 128 of tape drive 100 via network 130 are of similar design as host computer A.

In operation any of the host computers A, B, C, etc. can act as requestors independently from each other and send media control requests to the tape drive 100. Each media control request received by tape drive 100 carries the identifier of the requesting host computer.

The media control request is executed by instructions 116 and the instructions 118 generate a log entry that at least comprises an indication of the type of the received media control request and the identifier of the requestor from which the media control request has been received.

In some embodiments, the instructions 124 are invoked in order to examine the current media control request and a previous media control request for identification of a potentially conflicting situation. Without restriction of generality, the following example is considered

Host computer C executes its backup and/or archive application program 134. Backup and/or archive application program 134 sends a sequence of write commands 142, 144, 146, etc. to tape drive 100 via network 130. Each of the write commands 142, 144, 146, etc. carries the identifier of host computer C as stored in storage 138 of host computer C.

Concurrently, back up and/or archive application program 134 of host computer A sends rewind command 148 to tape drive 100 via network 130. The rewind command 148 carries the identifier A of the host computer A that is read from storage 138 of host computer A.

The concurrent rewind command 148 results in an interleaved command sequence received by the interface 128 of tape drive 100. The first media control request received by interface 128 is write command 142 followed by write command 144. Write command 144 is followed by rewind command 148. Finally, write command 146 is received.

When tape drive 100 receives the first write command 142 at its interface 128, the write command 142 is executed by instructions 116, and instructions 118 are invoked to generate a log entry and write the log entry to log 120. The log entry indicates the type of the received command and the identifier of the requestor from which the command has been received. For write command 142, the log entry that is generated by the instructions 118 indicates ‘write’ as the command type and ‘C’ as the identifier of the requesting host computer C.

When the consecutive write command 144 is received, instructions 118 generate a respective log entry that is stored in a consecutive storage location of log 120. The log entry that is generated for the rewind command 148 received from host computer A comprises ‘rewind’ as a type indication and ‘A’ as the identifier of the requester from which the command has been received. Again this log entry is stored at a consecutive storage location within log 120.

When write command 146 is received, this results in a corresponding log entry following the log entry for the rewind command 148, etc. When the log is full, the oldest log entry is replaced by the newest log entry using a circular replacement mechanism.

The analysis application program 136 of one of the host computers, such as host computer C, reads the log 120 during or after completion of the backup and/or archiving operation performed by backup and/or archive application program 134. The analysis application program 136 displays the log entries stored in log 120 on the display 140 coupled to the respective host computer system, such that a user can review the history of media control requests received by tape drive 100. On this basis, a user can detect potentially conflicting commands in order to decide whether the backup and/or archiving procedure was successfully completed or not. This process can also be performed automatically if analysis application program 130 uses rule base 126 of tape drive 100 or has a copy of rule base 126 for automatic identification of potentially conflicting commands stored in the log 120.

It is however preferred, in some embodiments, that tape drive 100 continuously checks the incoming command sequence by means of the instructions 124 in order to identify potentially conflicting commands in order to take immediate action if such potentially conflicting commands are identified.

For this purpose, instructions 124 read the previous entry of log 120 when a new command is received. The newly received current command and the previous command or command type stored in log 120 are compared with the error patterns stored in rule base 126, if the previous command and the current command have been received from different requestors.

If the previous command and the current command or command types are matching one or more of the error patterns stored in the rule base 126, the instructions 124 generate error messages 140 that are sent to the affected host computers from interface 128 via network 130.

In the example considered here, the instructions 124 identify rewind command 148 followed by write command 146 as potentially conflicting commands, using log 120 and the rule base 126, as this situation matches error pattern P1. As a consequence the instructions 124 generate the error messages 150 that are sent to the affected requestors, e.g., host computers A and C, in the example considered here. In response to error message 150, backup and/or archive application program 134 terminates its backup and/or archiving procedure. After analysis and correction of the misconfiguration that caused error messages 150, backup and/or archive application program 134 is re-started for repetition or completion of the backup and/or archiving process. Alternatively, the host that issued the rewind command has the status ‘failed’ returned to it, and the backup job is left to complete its issuance of command as normal.

In some embodiments, status messages of the tape drive are used to communicate the occurrence of such an error to the hosts. The tape drive sends status messages in response to host commands. The following shows a sequence of host commands received by a tape drive and the tape drive status message the tape drive sends to the host in response.

| Host commands | Tape drive response |
|---|---|
| Write from host A | Good status |
| Write from host A | Good status |
| Rewind from host B | Bad status |
| Read status from host B | Return actual status info. |

The above example illustrates the detection of a command conflict. The status messages returned by the tape drive communicate the occurrence of the error back to the “at fault” computer (B). For example, each host computer can continue normal interaction with the tape drive as long as it gets good status back in response to each command.

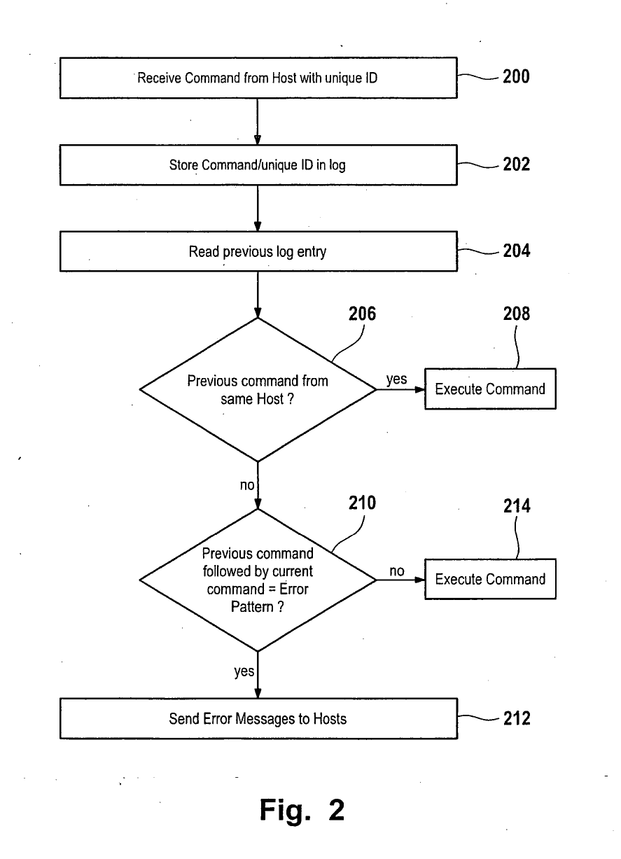

FIG. 2 shows a flowchart illustrating one embodiment of mode of operation of tape drive 100 of FIG. 1. In step 200, a command, such as a media control request, is received from a requestor, such as a host computer. The command carries the identifier of the host computer that has sent the command.

In step 202, at least the type of the command or the complete command is stored in the log of the tape drive along with the identifier of the requesting host computer. This current log entry is stored in the log for later reference.

In step 204, the log entry that has been previously stored in the log is read by the tape drive. This includes the identifier of the host computer that has sent the previous command which resulted in the previous log entry. In step 206, the identifier of the previous log entry and the identifier of the command received in step 202 are compared in order to make a determination whether the host computer that has sent the previous command and the host computer that has sent the current command are identical.

If the host computers are identical, the current command received in step 202 is executed in step 208. If the contrary is the case, the control goes to step 210. In step 210, the types of the previous command and the current command are compared against a set of error patterns.

If the sequence of the previous command and the current command matches one or more of the error patterns, the previous command and the current command are considered to be at least potentially conflicting. In this case, the control goes to step 212 where error messages are sent to the affected host computers, e.g., the host computer identified by the identifier of the previous log entry and the host computer identified by the identifier of the current log entry.

Alternatively, the occurrence of an error is communicated back to the concerned host computer by means of the status messages of the tape drive. If the previous command followed by the current command does not match one of the error patterns, the control goes to step 214 for execution of the current command.

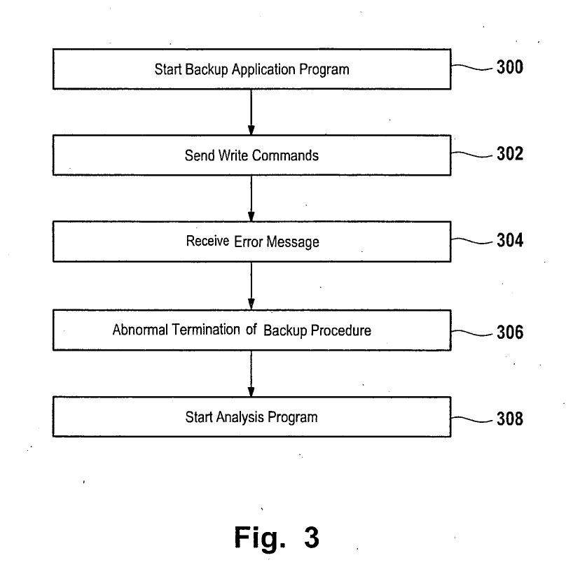

FIG. 3 illustrates one implementation of the backup and/or archive application program and analysis application program of FIG. 1. In step 300, the backup and/or archive application program is started to initiate a backup and/or archiving procedure. In step 302, the backup and/or archive application program starts to send a sequence of write commands to the tape drive for writing backup data.

In step 304, the backup and/or archive application program receives an error message from the tape drive during the ongoing backup and/or archiving procedure. The error message signals to the backup application program that the tape drive has received a potentially conflicting command from another host computer or other kind of requester.

In response, the backup and/or archive application program terminates the backup and/or archive procedure and displays a warning in order to inform a user of the abnormal termination. In some embodiments, the backup or archive application is rescheduled to restart after a suitable delay. In step 308, the user of the backup and/or archive application program starts the analysis application program for reading the log from the tape drive and analyzing the log entries for identification of the cause of the error.

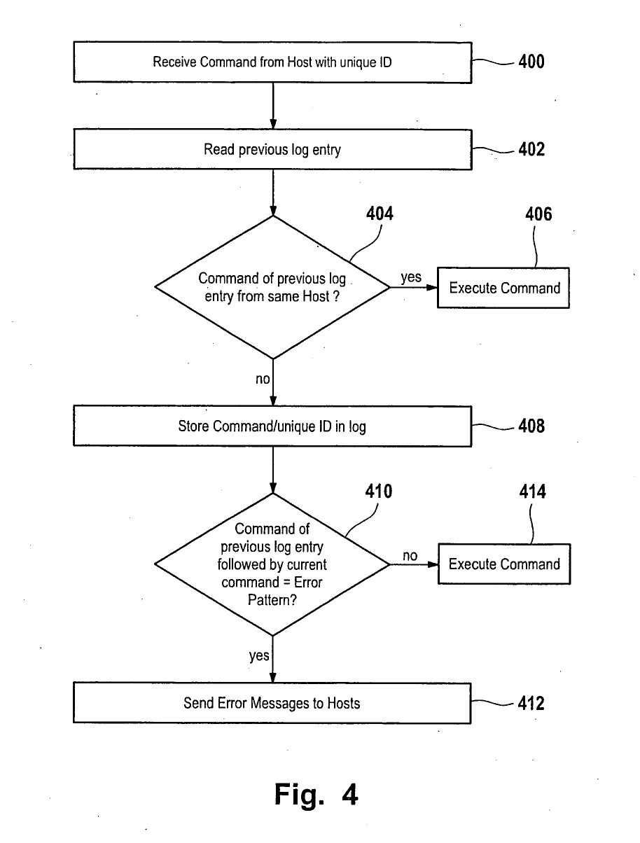

FIG. 4 is a flowchart illustrating an alternative to the embodiment of the method illustrated in FIG. 2. Step 400 is identical to step 200 of FIG. 2. In step 402, the previous log entry is read from the log by the tape drive. In step 404, the identifier stored in the previous log entry is compared with the identifier received as part of the command in step 400. If both identifiers are identical, the command received in step 400 has been received from the same host as the command that has caused the previous log entry. As a consequence, it is assumed that the previous and the current commands cannot interfere such that the current command is executed in step 406.

Only if the current command has been received from a different host computer than the command that has caused the previous log entry, the control goes to step 408 where a new log entry is generated, and at least the type of the current command along with the identifier of the host that has sent the command is stored in the log.

In step 410, the previous command stored in the previous log entry, and the current command that has been received in step 400 are compared with the set of error patterns. If the types of the previous command followed by the current command match at least one of the error patterns, the control goes to step 412 which is identical to step 212 of FIG. 2. If the contrary is true the control goes to step 414 for execution of the current command (cf. step 214 of FIG. 2).

The embodiment of the method of FIG. 4 has the advantage that the number of log entries is drastically reduced as only commands that are received from alternate hosts result in additional log entries. Apart from the reduction of the log size this also simplifies analysis of the log.

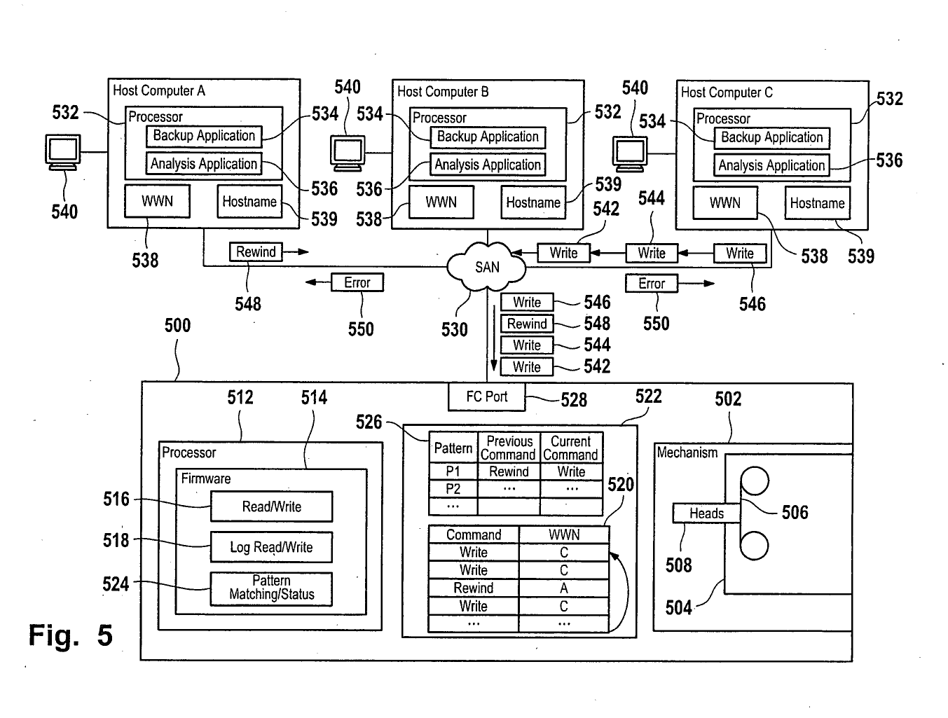

FIG. 5 shows an alternative embodiment. Elements of FIG. 5 that correspond to elements of FIG. 1 are designated by like reference numerals having added 400. In the embodiment considered in FIG. 5, the host computers A, B, C, etc. are coupled to tape drive 500 via SAN 530. Tape drive 500 is coupled to SAN 530 by means of its FibreChannel (FC) port 528. The host computers A, B, C, etc. have respective FC ports (not shown in FIG. 5). Each one of the host computers has a world wide name (WWN) which is stored in storage 538. In addition, each one of the host computers A, B, C, etc. can have an assigned host name which is stored in storage 539.

Typically, the WWN of the FC interface of each host port is pre-assigned at the time of manufacture of the interface. Hence, the WWN is a fixed identifier for each FC host port. Note that a host may have multiple FC ports; if there are multiple FC ports, usually each one has a WW Port Name. The FC protocol is designed to automatically communicate the WWN of a FC port from which a command is sent as part of the protocol. In the case of multiple FC ports on a single host, there is potential for the backup application running on that host to send individual commands via differing FC ports. These ports must be recognized as belonging to the same host in order for the tape drive to accurately determine that this traffic is all coming from the same host. The tape drive can do this by referring to the WW Node Name rather than the WW Port Name within incoming FC traffic.

In accordance with the FC protocol, the WWN of the sending host computer of a command is communicated to the recipient of the command, e.g., tape drive 500. The WWN is used by the instructions 518 as the identifier for creating the log entry into the log 520.

It should be emphasized that the above-described embodiments of the present disclosure are merely possible examples of implementations, merely set forth for a clear understanding of the principles of the disclosure. Many variations and modifications may be made to the above-described embodiments without departing substantially from the spirit and principles of the present disclosure. All such modifications and variations are intended to be included herein within the scope of this disclosure.

Therefore, at least the following is claimed:

1. A tape drive apparatus comprising:
an interface for coupling at least first and second requestors to the tape drive apparatus, the interface being adapted to receive media control requests from the requestors and identifiers of the requestors; and
logic circuitry for generating log entries and writing the log entries to a log, each log entry indicating at least a type of one of the media control requests and the identifier of the respective requestor, the logic circuitry being adapted for identification of potentially conflicting ones of the media control requests received from different ones of the at least first and second requesters.

2. The tape drive apparatus of claim 1, wherein the log is circular.

3. The tape drive apparatus of claim 1, the logic circuitry being adapted to write a log entry for each of the media control requests.

4. The tape drive apparatus of claim 1, the logic circuitry being adapted to write a log entry for a current one of the media control requests, if a previous one of the media control requests has been received from a different requestor than the current one of the media control requests.

5. The tape drive apparatus of claim 4, the logic circuitry being adapted to read a previous log entry in order to determine if the requestors of the previous one of the media control requests and the current one of the media control requests are different.

6. The tape drive apparatus of claim 1, further comprising a rule base, the logic circuitry being adapted to use the rule base for identification of the potentially conflicting ones of the media control requests.

7. The tape drive apparatus of claim 1, further comprising a memory for storing a set of error patterns, each error pattern comprising at least first and second consecutive types of media control requests, the logic circuitry being adapted to use the set of error patterns for identification of potentially conflicting ones of the media control requests received from different requestors.

8. The tape drive apparatus of claim 7, the set of error patterns having an error pattern comprising a rewind-type media control request followed by a write-type media control request.

9. The tape drive apparatus of claim 6, the logic circuitry being adapted to read a previous log entry for the identification of the potentially conflicting ones of the media control requests.

10. The tape drive apparatus of claim 6, the logic circuitry being adapted to generate an error signal if potentially conflicting ones of the media control requests are identified.

11. The tape drive apparatus of claim 6, wherein the interface for receiving the media control requests is a FibreChannel compliant port and worldwide names of the requesters are used as the identifiers.

12. A computer program product for controlling a tape drive, the computer program product comprising instructions for:
receiving media control requests from requesters coupled to the tape drive and identifiers of the requesters;
generating log entries and writing the log entries to a log of the tape drive, each log entry indicating at least a type of one of the media control requests and the identifier of the respective requestor; and
identification of potentially conflicting ones of the media control requests received from different ones of the requestors using the log entries.

13. The computer program product of claim 12, the instructions being adapted to write a log entry for each of the media control requests.

14. The computer program product of claim 12, the instructions being adapted to write a log entry for a current one of the media control requests, if a previous one of the media control requests has been received from a different requestor than the current one of the media control requests.

15. The computer program product of claim 14, the instructions being adapted to read a previous log entry in order to determine if the requesters of the previous one of the media control requests and the current one of the media control requests are different.

16. The computer program product of claim 12, the instructions being adapted to use a rule base for the identification of the potentially conflicting ones of the media control requests.

17. The computer program product of claim 12, the instructions being adapted to use a set of error patterns for identification of potentially conflicting ones of the media control requests received from different requesters, each error pattern comprising at least first and second consecutive types of media control requests.

18. The computer program product of claim 17, the set of error patterns having an error pattern comprising a rewind-type media control request followed by a write-type media control request.

19. A method of writing log entries to a log of a tape drive apparatus, the method comprising:
receiving media control requests from requestors coupled to the tape drive and identifiers of the requestors;
generating log entries and writing the log entries to a log of the tape drive, each log entry indicating at least a type of one of the media control requests and the identifier of the respective requester; and
identifying potentially conflicting ones of the media control requests received from different requesters using the log entries.

20. The method of claim 19, wherein the log entry is written to the log for each of the media control requests.

21. The method of claim 19, wherein the log entry is written for a current one of the media control requests if a previous one of the media control requests has been received from a different requester than the current one of the media control requests.

22. The method of claim 19, further comprising reading a previous log entry in order to determine if the requestors of a previous one of the media control requests and a current one of the media control requests are different.

23. The method of claim 19, further comprising using a rule base for identification of the potentially conflicting ones of the media control requests.

24. The method of claim 19, further comprising using a set of error patterns for identification of potentially conflicting ones of the media control requests received from different requestors, the set of error patterns having an error pattern comprising at least first and second consecutive types of media control requests.

25. The method claim 19, further comprising read a previous log entry for the identification of the potentially conflicting ones of the media control requests.

26. The method of claim 19, further comprising generating an error signal if potentially conflicting ones of the media control requests are identified.

27. A computer program product for analysing a log of a tape drive, each log entry of the log indicating at least a type of one of a plurality of media control requests received from a plurality of requesters and the identifier of the respective requester, the computer program product comprising instructions for:
reading the log from the tape drive; and
displaying log entries for review by a user.

28. The computer program product of claim 27 operable to automatically identify potentially conflicting ones of the media control requests received from different requestors.

29. A sequential storage apparatus comprising:
means for coupling at least first and second computers to the sequential storage apparatus, the means for coupling being adapted to receive media control requests from the computers and identifiers of the computers;
means for generating log entries and writing the log entries to a log, each log entry indicating at least a type of one of the media control requests and the identifier of the respective computer; and
means for identification of potentially conflicting ones of media control requests received from different computers using the log entries.

30. The sequential storage apparatus of claim 29, further comprising signalling means for signalling an error to the different computers, if potentially conflicting ones of the media control requests are identified.
